(19) United States
(12) Patent Application Publication
(10) Pub. No.: US 2026/0025163 A1
(43) Pub. Date: Jan. 22, 2026

(54) ADAPTIVE SCHEDULING FOR INDOOR NAVIGATION USING UWB ANCHOR INFRASTRUCTURE

(71) Applicant: QUALCOMM Incorporated, San Diego, CA (US)

(72) Inventors: Varun Amar REDDY, San Diego, CA (US); Pooria PAKROOH, San Marcos, CA (US); Aleksandar DAMNJANOVIC, Del Mar, CA (US); Krishna Kiran MUKKAVILLI, San Diego, CA (US)

(21) Appl. No.: 18/774,231

(22) Filed: Jul. 16, 2024

(51) Int. Cl. H04B 1/719; H04W 72/12; H04W 72/542

(52) U.S. Cl. CPC H04B 1/719; H04W 72/12; H04W 72/542

(57) ABSTRACT

A method for adaptive scheduling of Ultra-Wideband (UWB) transmissions for one or more UWB anchors in a UWB network includes: receiving one or more interference reports from the one or more UWB anchors comprising one or more signal quality measurements of one or more UWB signals experiencing interference; and sending one or more UWB transmission schedules based on the one or more interference reports to the one or more UWB anchors. The one or more UWB anchors may be assigned to transmit messages over one or more UWB channels such that effects of interference may be mitigated or avoided without requiring modification of the signal transmission schedule of other signals.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax®), a fifth-generation (5G) service (e.g., 5G New Radio (NR)), etc., with a sixth-generation (6G) service in development. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

Sixth generation (6G) networks are expected to be significantly faster than previous network generations, more diverse than previous network generations, and able to support new applications. It is expected that 6G networks will operate in frequency bands used by other applications, e.g., Ultra-Wideband (UWB) applications for communication in a 3.1 GHz to 10.6 GHz frequency spectrum. For instance, a comprehensive specification of UWB applications can be found, for instance, in IEEE Std. 802.15.4z-2020 discussing Enhanced Ultra-Wideband (UWB) Physical Layers (PHYs) and Associated Ranging Techniques.

### SUMMARY

An example method for adaptive scheduling of Ultra-Wideband (UWB) transmissions for one or more UWB anchors in a UWB network includes: receiving one or more interference reports from the one or more UWB anchors comprising one or more signal quality measurements of one or more UWB signals experiencing interference; and sending one or more UWB transmission schedules based on the one or more interference reports to the one or more UWB anchors.

An example UWB device includes: at least one transmitter; at least one memory; and at least one processor, communicatively coupled to the at least one transmitter and the at least one memory, with at least one of the at least one memory or the at least one processor comprising instructions to cause the at least one processor to: receive one or more interference reports from one or more UWB anchors in a UWB network, the one or more interference reports comprising one or more signal quality measurements of one or more UWB signals experiencing interference; and send one or more UWB transmission schedules based on the one or more interference reports to the one or more UWB anchors.

Another example UWB device includes: means for receiving one or more interference reports from one or more UWB anchors in a UWB network, the one or more interference reports comprising one or more signal quality measurements of one or more UWB signals experiencing interference; and sending the one or more UWB transmission schedules based on the one or more interference reports to the one or more UWB anchors.

### BRIEF DESCRIPTION OF THE DRAWINGS

FIG. 1 is a diagram of an example Ultra-Wideband (UWB) communications system.

FIG. 2 is a block diagram of an example of a UWB tag.

FIG. 3 is a block diagram of an example of a UWB anchor.

FIG. 4 is a diagram of frequency spectrum for Radio Access Technology (RAT) signals and UWB signals.

FIG. 5A is a timing diagram of a processing and signal flow of a ranging session.

FIG. 5B is a timing diagram of another processing and signal flow of a ranging session.

FIG. 6 is a block diagram of a portion of a UWB ranging block.

FIG. 7 is a timing diagram of a ranging round within the UWB ranging block shown in FIG. 6 and compared with a RAT frame.

FIG. 8 is a block diagram of signaling in a UWB network for a localization service.

FIG. 9 is a block diagram of signaling in a UWB network for inter-cluster synchronization.

FIG. 10 is a timing diagram of a processing and signal flow for generating a UWB transmission schedule based on interference from RAT signals.

FIG. 11 is a diagram of an example schedule for scanning UWB signals for RAT signal interference by a cluster of UWB anchors.

FIG. 12 is a diagram of an example UWB transmission schedule.

FIG. 13 is a block flow diagram of a method for adaptive scheduling of UWB transmissions for one or more UWB anchors in a UWB network.

### DETAILED DESCRIPTION

Techniques are discussed herein for an adaptive scheduling of Ultra-Wideband (UWB) transmissions for one or more UWB anchors in a UWB network. The UWB anchors in the UWB network may learn the pattern of Radio Access Technology (RAT) signal interference and adapt one or more UWB transmission schedules to avoid or mitigate the interference from the RAT signals. In the adaptive scheduling, a scheduling controller transmits a request to the UWB anchors in the UWB network to measure the interference experienced by the UWB signals and to return to the scheduling controller one or more interference reports. The scheduling controller generates one or more UWB transmission schedules based on the interference reports by, for example, assigning the UWB anchors to transmit over UWB channels with the least amount of interference.

Items and/or techniques described herein may provide one or more of the following capabilities, as well as other capabilities not mentioned. Interference from RAT transmissions operating in the same or similar frequency spectrum as UWB devices may be mitigated or avoided for UWB signal transmissions, without requiring modification of the RAT signal transmission schedule. UWB ranging performance (e.g., success rate of UWB communications) may be improved. Other capabilities may be provided and not every implementation according to the disclosure must provide any, let alone all, of the capabilities discussed.

The description herein may refer to sequences of actions to be performed, for example, by elements of a computing device. Various actions described herein can be performed by specific circuits (e.g., an application specific integrated circuit (ASIC), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various examples described herein may be embodied in a number of different forms, all of which are within the scope of the disclosure, including claimed subject matter.

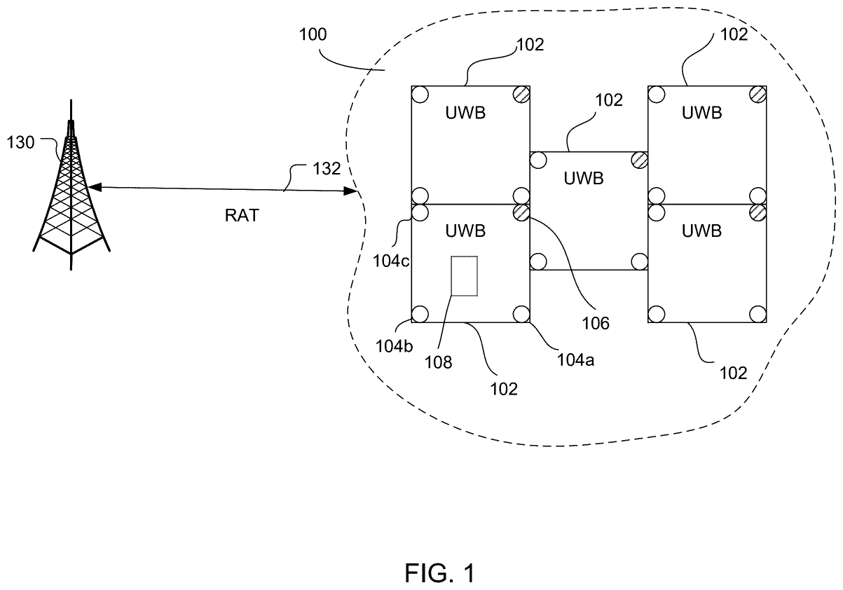

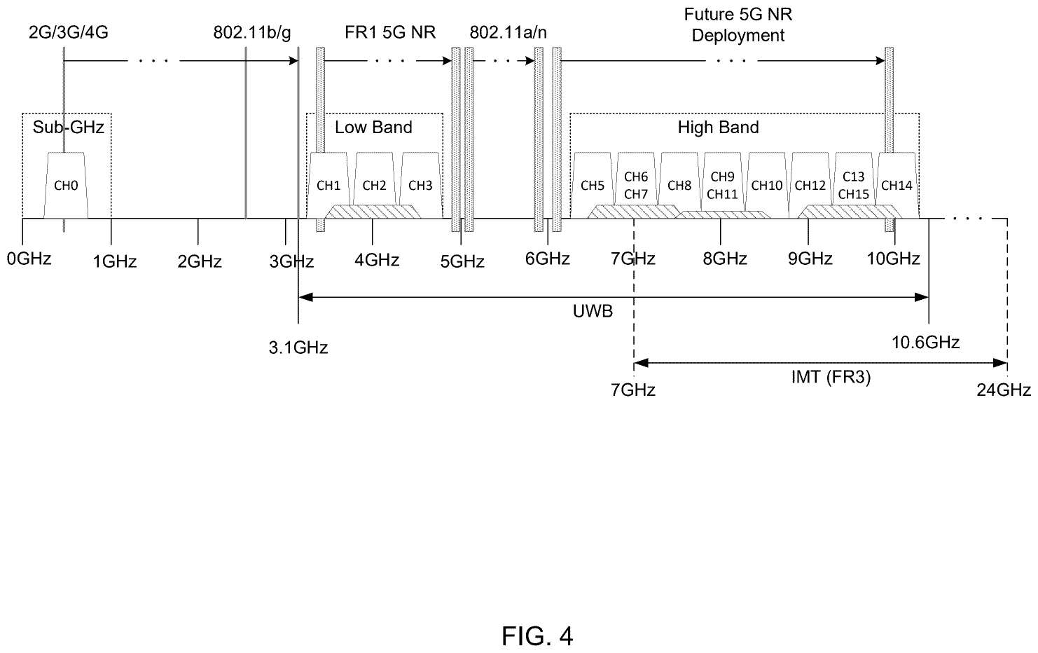

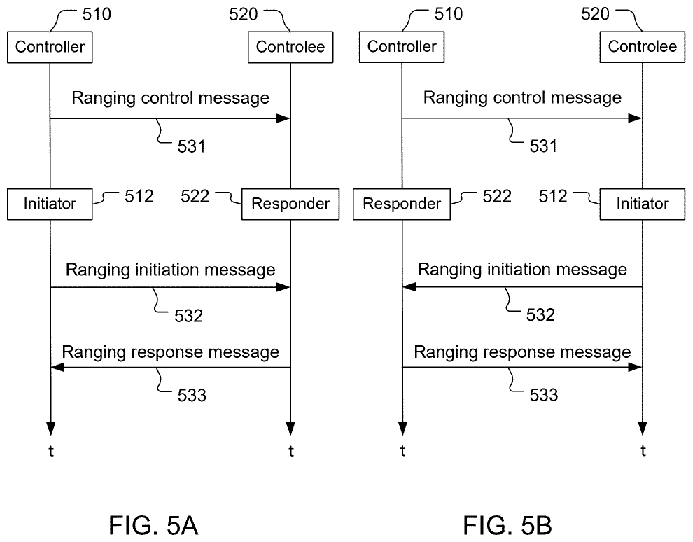

Referring to FIG. 1, a UWB network 100 includes one or more UWB devices (e.g., UWB anchors 104a, 104b, 104c, 106, 108). The UWB devices include one or more UWB anchors 104a-104c, 106 and one or more UWB tags 108. The UWB anchors 104a-104c, 106 may be configured as members of one or more clusters 102. Each cluster 102 may be configured such that one of the UWB anchors (e.g., UWB anchor 106) may function as an initiator, and the remaining UWB devices (e.g., UWB anchors 104a, 104b, 104c) in the cluster 102 may function as responders, as described further below with reference to FIGS. 5A and 5B. The UWB anchors 104a-104c, 106 may communicate with each other through UWB signaling, e.g., the transfer of UWB signals. To provide coverage across a building, such as a mall or an office, multiple clusters 102 of UWB anchors 104a-104c, 106 may be deployed. A UWB tag 108 (e.g., a user equipment, such as a mobile device) may connect with one or more clusters 102 in the UWB network 100 and may passively receive messages from the UWB anchors 104a-104c, 106 for certain services, such as a localization service. The transmission of the UWB signals in the UWB network 100 may overlap with the transmission of RAT signals 132, such as from a cellular network 130. The UWB network 100 may experience interference from the RAT signals 132, as described further below with reference to FIG. 4.

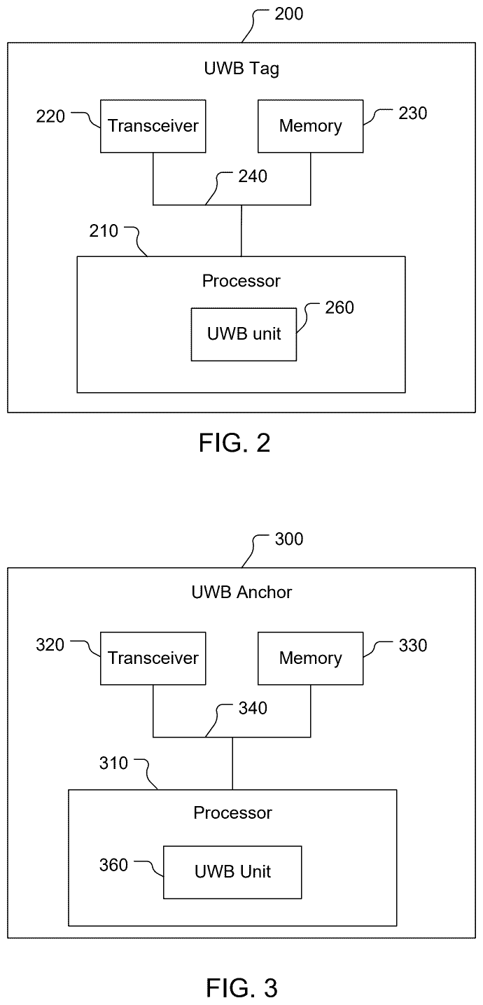

Referring to FIG. 2, a UWB tag 200 may include a processor 210, a transceiver 220, and a memory 230 communicatively coupled to each other by a bus 240. Even if referred to in the singular, the processor 210 may include one or more processors, the transceiver 220 may include one or more transceivers (e.g., one or more transmitters and/or one or more receivers), and the memory 230 may include one or more memories. The processor 210 (possibly in conjunction with the memory 230 and, as appropriate, the transceiver 220) may include a UWB unit 260. The UWB unit 260 may be configured to passively receive messages over one or more UWB channels from one or more UWB anchors. The configuration of the UWB tag 200 shown in FIG. 2 is an example and not limiting of the disclosure, including the claims, and other configurations may be used.

Referring also to FIG. 3, a UWB anchor 300 includes a processor 310, a transceiver 320, and a memory 330 communicatively coupled to each other by a bus 340. Even if referred to in the singular, the UWB anchor 300 may include one or more network entities, the processor 310 may include one or more processors, the transceiver 320 may include one or more transceivers (e.g., one or more transmitters and/or one or more receivers), and the memory 330 may include one or more memories. The UWB anchor 300 may include the components shown in FIG. 3 and may be configured to be one or more UWB devices of a UWB communication network. The description herein may refer to the processor 310 performing a function, but this includes other implementations such as where the processor 310 executes software (stored in the memory 330) and/or firmware. The description herein may refer to the UWB anchor 300 performing a function as shorthand for one or more appropriate components (e.g., the processor 310 and the memory 330) of the UWB anchor 300 performing the function. The processor 310 (possibly in conjunction with the memory 330 and, as appropriate, the transceiver 320) may include a UWB unit 360. The UWB unit 360 may be configured to measure the quality of UWB signals. The UWB unit 350 is discussed further below, and the description may refer to the processor 310 generally, or the UWB anchor 300 generally, as performing any of the functions of the UWB unit 350, with the UWB anchor 300 being configured to perform the function(s). The configuration of the UWB anchor 300 shown in FIG. 3 is an example and not limiting of the disclosure, including the claims, and other configurations may be used.

The UWB anchor 300 may use pulse-based radio signaling (e.g., short-pulse-UWB) instead of OFDM-based signaling (Multi-Band OFDM UWB (MB-OFDM-UWB)). Short-pulse-UWB signaling transmits with the energy for each bit spread over the entire UWB channel bandwidth (e.g., 1.37 GHZ, 4 GHZ, etc.) with varying pulse amplitude and/or pulse polarity without using an RF carrier, while MB-OFDM-UWB transmits each bit using a 4 MHz bandwidth channel.

Using short-pulse-UWB signaling systems may provide several advantages over MB-OFDM-UWB signaling systems and other OFDM-based systems. For example, a short-pulse-UWB signaling system may provide better fading characteristics (e.g., Gaussian-modeled fading versus Rayleigh-modeled fading, and/or less than 1% of channels experiencing 2 dB or more fading) than an MB-OFDM-UWB signaling system. As other examples, a short-pulse-UWB signaling system may operate accurately without employing FEC (Forward Error Correction), using no-rake processing, with lower peak-to-average RF, and/or with longer battery life than an MB-OFDM-UWB signaling system. Short-pulse-UWB also does not use traditional modulation and demodulation techniques such as Fast Fourier Transforms (FFT) but may use time-domain or space-time processing techniques. Short-pulse-UWB may utilize various pulse shapes (e.g. Gaussian pulses, Monocycle pulses, Hermite pulses, etc.) and the shape used may be chosen based on pulse properties in time and frequency domains among other factors, such as Bandwidth utilization, Interference Mitigation, Power Spectral Density, Multipath fading and inter-symbol interference, design complexity, power consumption, range, tradeoffs for ultra-fast sampling, etc. Short-pulse-UWB, in some cases, may benefit from a high-speed Analog-to-Digital converter (ADC) and a high-speed Digital-to-Analog Converter (DAC) to be able to handle the very wide frequency band used; however, there may be other ways to handle ultra-fast sampling such as using Time Hopping techniques, Direct Sequence coding techniques, etc.

Multi-Band OFDM UWB divides up spectrum into several frequency sub-bands and OFDM is applied within each band; whereas other OFDM systems typically operate within a fixed frequency band. The complex waveform created by combining the multiple-sub-bands results in a final waveform that is used for transmission for MB-OFDM-UWB. Multi-Band OFDM UWB also differs from other OFDM systems by not using a guard interval, by using simpler modulation schemes like Binary Phase Shift keying (BPSK) or Quadrature phase-shift keying (QPSK) versus 64 or 256 Quadrature Amplitude Modulation (QAM), by using a constant power whereas other OFDM systems may use power control for varying channel conditions, etc.

Referring to FIG. 4, a new spectrum may be used for next generation (e.g., 6G) RAT signals (e.g., IMT (FR3) signals with a frequency between 7.125 GHz and 24.25 GHz), and this new spectrum may overlap with the UWB spectrum (signals with a frequency between 3.1 GHz and 10.6 GHZ). RAT signals that use the same spectrum as UWB anchors may cause interference with UWB signals, especially because UWB signal transmit power is-14.3 dBm or less, and RAT signal transmit power may be approximately 40 dBm.

Referring to FIGS. 5A and 5B, a UWB anchor (e.g., UWB anchor 300) may be a controller or a controlee and may be an initiator or a responder. A UWB anchor is a UWB device that is configured to communicate with another UWB anchor using UWB signals. A UWB controller (which may be referred to herein as a controller) is an Enhanced Ranging Device (ERDEV) that is configured to control a UWB ranging session, to define ranging parameters, and to provide the ranging parameters to another UWB anchor by sending a Ranging Control Message (RCM). The RCM may be sent over a UWB link and/or over another communication link (e.g., a WiFi or NR (New Radio)). The RCM contains metrics (e.g., selected channel, transmit power, timing information) for how a UWB session will function. The controller may be configured to update ranging parameters during an ongoing session by sending a Ranging Control Update Message (RCUM), e.g., periodically. A UWB controlee (which may be referred to herein as a controlcc) is an ERDEV that is configured to use the ranging parameters received from the controller in the RCM or RCUM in order to transmit and/or receive UWB ranging messages. An initiator is an ERDEV that uses information from the RCM to initiate a ranging transfer by sending a Ranging Initiation Message (RIM) to a responder. A controller or a controlee may be an initiator or a responder. A responder is an ERDEV that responds to the RIM received from the initiator by sending a Ranging Response Message (RRM) to the initiator. The RIM and/or RRM may be measured for positioning, e.g., to determine a time of arrival (ToA) estimate and/or an angle of arrival (AoA) estimate, etc. The initiator and responder provide two-way ranging, which can correct clock offset errors between the initiator and the responder, which may improve the accuracy of a ToA estimate and the accuracy of an overall range (and thus position) estimate. For example, as shown in FIG. 5A, a controller 510 sends an RCM 531 to a controlee 520. The controller 510, acting as an initiator 512, sends an RIM 532 to the controlee 520, that is acting as a responder 522. The responder 522 responds to the RIM 532 by sending an RRM 533 to the initiator 512. As another example, as shown in FIG. 5B, the controller 510 sends the RCM 531 to the controlee 520. The controlee 520, acting as the initiator 512, sends the RIM 532 to the controller 510, that is acting as the responder 522. The responder 522 responds to the RIM 532 by sending the RRM 533 to the initiator 512.

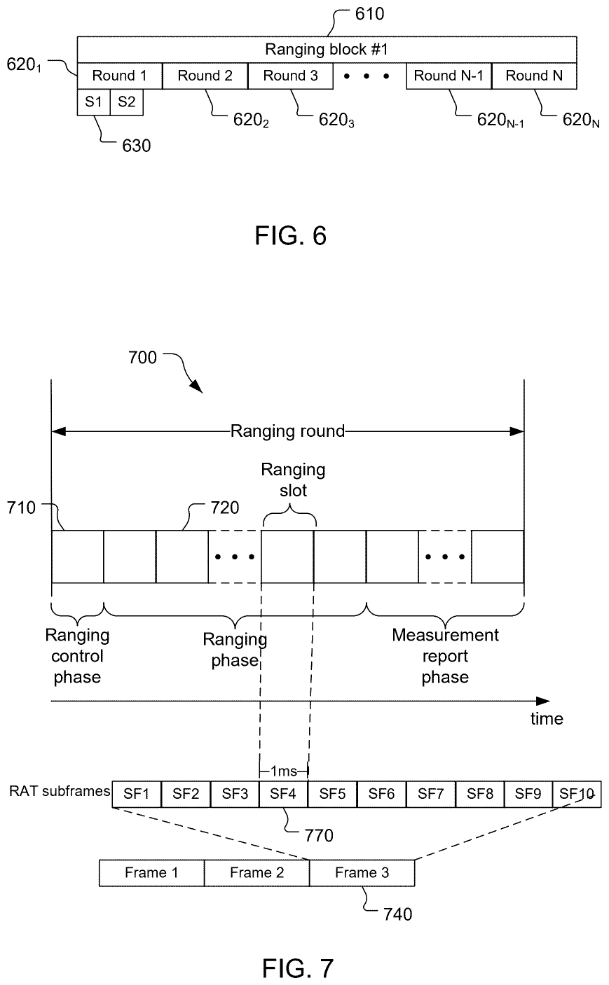

Referring also to FIG. 6, a UWB session comprises consecutive ranging blocks, which are blocks of time. Each ranging block, such as a ranging block 610, may have a duration between 200 ms and 250 ms. Each ranging block includes multiple rounds, e.g., rounds 620₁, 620₂, 620₃, . . . , 620_{N-1}, 620_{N}, with each round being between 10 ms and 20 ms. Each of the rounds 620₁-620_{N} includes ranging slots 630, with each of the slots 630 being between 1 ms and 2.66 ms in duration. A ranging packet within a slot may have a duration up to 1 ms, e.g., a duration of about 150 μs, while a remainder of the slot may be retained for processing delays. The quantity N of the rounds 620₁-620_{N} within the ranging block 610 may be configured by the UWB controller, e.g., the controller 510. Transmissions for any given ranging block occur within a selected one of the rounds, with no transmissions being sent by either UWB device of the session during the other (non-selected) rounds. The selected round for any particular ranging block may be statically configured in the RCM by the controller, or may be selected per a hopping pattern. The hopping pattern may be a formula that is known by the initiator and the responder, and the initiator and the responder may apply the formula independently to send and receive ranging messages. The selection of a round may be used to help avoid interference of UWB sessions by RAT signals.

Referring also to FIG. 7, a ranging round 700 is divided into slots that may be used for various purposes. For example, a first slot 710 may be for a ranging control phase and thus reserved for transferring the RCM. A set of slots 720 is assigned to a ranging phase and used by the initiator and the responder to transfer, in alternating slots, the RIM and the RRM, respectively. Multiple RIMs and RRMs may be transferred in order to achieve a desired result (e.g., one or more measurements of sufficient accuracy). A RAT frame 740 may be 10 ms in duration, and thus on the order of the duration of the ranging round 700 if the ranging round 700 includes 10 slots each of about 1 ms in duration. Similarly, the RAT frame 740 may be divided into 10 subframes 740. A RAT subframe 770 may be 1 ms long, which is the same as a minimum duration for a UWB ranging slot. RAT signals transmitted during the 1 ms duration of a RAT subframe 770 may thus interfere with the UWB signals during the 1 ms duration of a corresponding ranging slot.

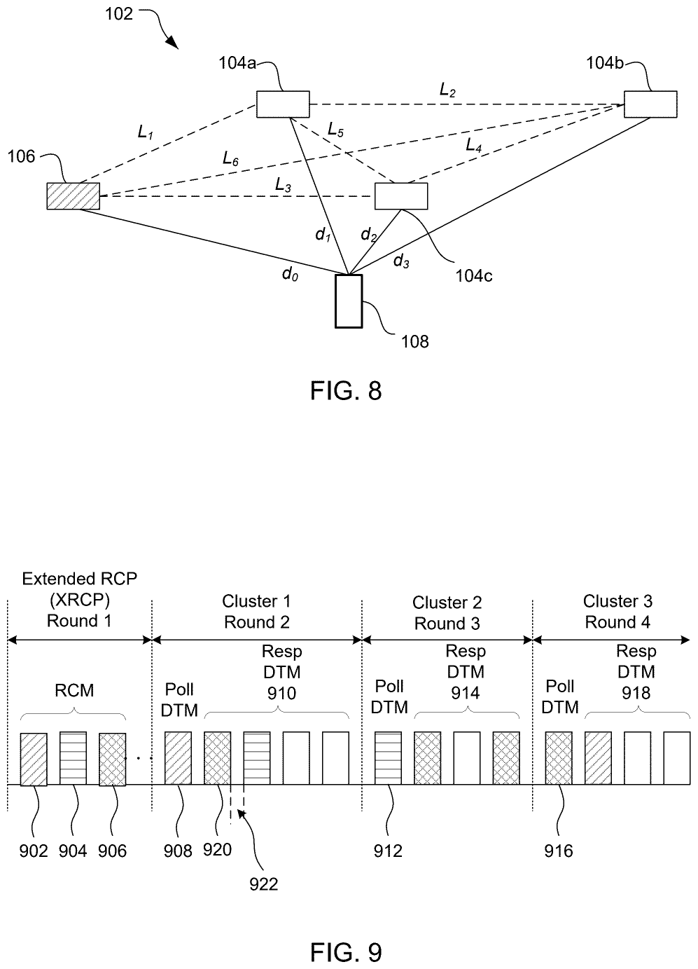

Referring to FIG. 8, the UWB anchors 104a-104c, 106 in a cluster 102 may be fine ranging devices that transmit downlink (DL) time difference of arrival (TDoA) messages (DTM) that can be used by the UWB tag 108 (e.g., UWB tag 200) to perform localization based on DL-TDoA. The UWB tag 108 may measure the reception times of each DTM that it receives, and the UWB tag 108 may utilize the reception timestamp, along with the obtained coordinates of the UWB anchors 104a-104c, 106 to estimate its position. For example, a cluster 102 of UWB anchors 104a-104c, 106 may exchange messages with each other to provide a localization service to the UWB tag 108. The UWB anchors 104a-104c, 106 in the cluster 102 may include one UWB anchor 106 configured as an initiator and one or more other UWB anchors 104a, 104b, 104c configured as responders. The initiator 106 may transmit a Poll-DTM (i.e., an RIM transmitted by the initiator), which includes control information for the cluster 102, such as a Ranging Device Management List (RDML) that contains a list of slot indices for the responders 104a, 104b, 104c to transmit RRMs back to the initiator 106. The initiator 106 and the responders 104a, 104b, 104c may use the messages to calculate ranges (L1, L2, L3, L4, L5) between the UWB anchors 104a, 104b, 104c, 106, which may then be used to estimate their respective positions. The UWB tag 108 may passively receive messages from the UWB anchors 104a-104c, 106 and to use the messages and the positions of the UWB anchors 104a-104c, 106 to calculate ranges d₀, d₁, d₂, d₃. The UWB tag 108 may be configured to use the ranges (d₀, d₁, d₂, d₃) to calculate the TDOA to the responders 104a, 104b, 104c as:

$$T D o {A}_{1} = ( {d}_{1} - {d}_{o} ) / c$$

$$T D o {A}_{2} = ( {d}_{2} - {d}_{o} ) / c$$

$$T D o {A}_{3} = ( {d}_{3} - {d}_{o} ) / c$$

where c is the speed of light. The UWB tag 108 may be configured to calculate its position based on TDoA₁, TDoA₂, and TDoA₃.

Referring again to FIG. 1, each cluster 102 of UWB anchors 104a-104c, 106 in the UWB network 100 may be assigned to a dedicated ranging round. In order to avoid “drift” in UWB transmissions across slot boundaries, inter-cluster synchronization enables overlapping clusters to operate over a common UWB channel but on different ranging rounds using a common ranging block structure. Referring to FIG. 9, to accomplish the synchronization, an extended control phase (XRCP) occurs in an initial round (i.e., ranging round 1). For example, the message exchange between three clusters (Cluster 1, Cluster 2, and Cluster 3) are shown. Each cluster is configured with an initiator. During the XRCP, the initiators of Cluster 1, Cluster 2, and Cluster 3 exchange RCMs 902, 904, and 906 with each other for the purpose of synchronizing the clusters, coordinating UWB transmission schedules, and assigning the clusters to specific rounds. Each initiator then transmits a Poll DTM containing control information, cluster assignments, and transmission schedules to each responder in their respective clusters during their assigned ranging round. For example, Cluster 1 may be assigned to ranging round 2, Cluster 2 may be assigned to ranging round 3, and Cluster 3 may be assigned to ranging round 4. During ranging round 2, the initiator for Cluster 1 may transmit a Poll DTM 908 to the responders assigned to Cluster 1. The responders in Cluster 1 may transmit Response DTMs 910 (i.e., RRMs) back to the initiator for Cluster 1. During ranging round 3, the initiator for Cluster 2 may transmit a Poll DTM 912 to the responders assigned to Cluster 2. The responders in Cluster 2 may transmit Response DTMs 914 back to the initiator for Cluster 2. During ranging round 4, the initiator for Cluster 3 may transmit a Poll DTM 916 to the responders assigned to Cluster 3. The responders in Cluster 3 may transmit Response DTMs 918 back to the initiator for Cluster 3. However, interference of the UWB communications between the initiator and responders from RAT signals 132 may compromise the ability of the initiator and responders to reliably exchange messages. Such interference compromises the initiator's and the responders' ability to synchronize, which may in turn compromise the quality of services (e.g., the localization service to the UWB tag 108).

In an example embodiment, and referring again to FIG. 1, the UWB network 100 may be configured to implement an adaptive scheduling of UWB transmissions for UWB anchors in a UWB network, where the UWB anchors learn the pattern of RAT signal interference and adapt one or more UWB transmission schedules to avoid or mitigate the interference from RAT signals 132. In the adaptive scheduling, a scheduling controller transmits a request to the UWB anchors in the UWB network 100 to measure the interference of the UWB signals due to RAT signals 132 and to return to the scheduling controller one or more interference reports. The scheduling controller generates one or more UWB transmission schedules based on the interference reports by, for example, assigning the UWB anchors to transmit over UWB channels with the least amount of interference. By generating the UWB transmission schedule(s) in this manner, the UWB anchors may transmit messages over assigned UWB channels such that the effects of RAT signal interference may be mitigated or avoided without requiring modification to the RAT signal transmission schedule.

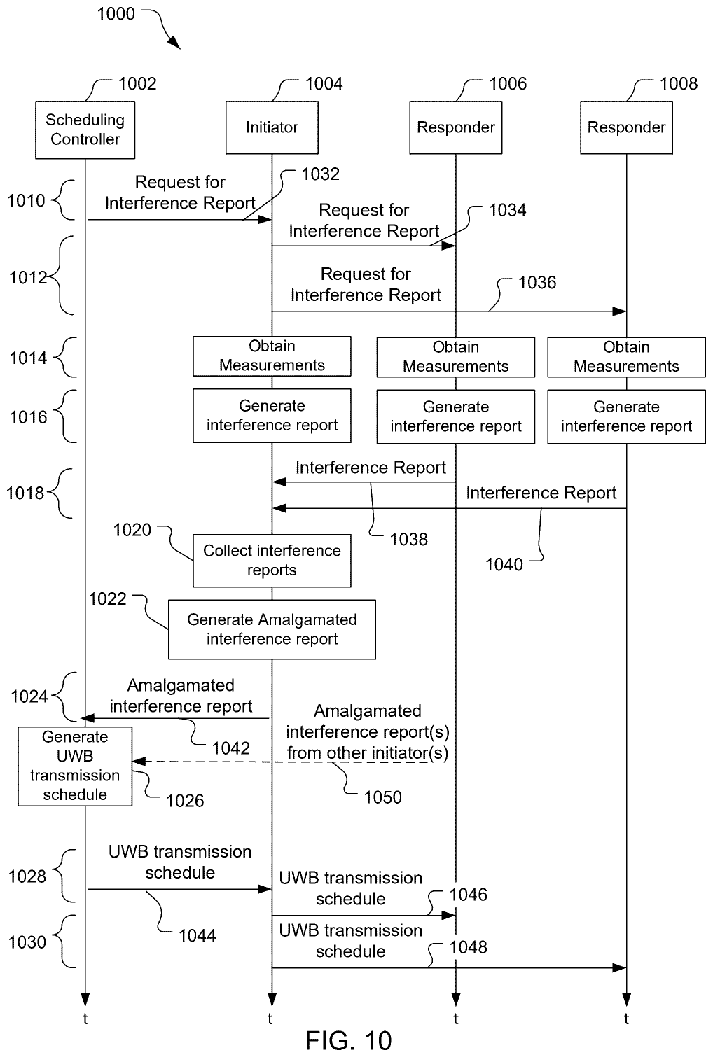

Referring to FIG. 10, a signal and processing flow for generating a UWB transmission schedule based on interference of the UWB signals from RAT signals includes the stages shown. The flow 1000 is an example flow and not limiting. The flow 1000 may be altered, e.g., by having one or more messages and/or one or more stages added, having one or more stages and/or one or more messages removed, and/or having one or more message and/or one or more stages split into multiple messages and/or stages.

In the flow 1000, signals are transferred among a scheduling controller 1002 and UWB anchors in each cluster. The cluster may be composed of UWB anchors, including an initiator 1004 and one or more responders 1006, 1008. Although the flow 1000 shows signals exchanged between the scheduling controller 1002 and the UWB anchors 1004, 1006, 1008 in one cluster, the same flow 1000 may be applicable for exchanging signals between the scheduling controller 1002 and other clusters in the same UWB network. In one embodiment, the scheduling controller 1002 may be a UWB anchor 300 configured to perform the functions of the scheduling controller and the initiator for a corresponding cluster. In another embodiment, a UWB anchor 300 may be configured to perform the functions of the controller 510 and the scheduling controller 1002. In another embodiment, an edge server may be configured to perform the functions of the scheduling controller 1002, where the edge server may further be configured to obtain interference reports from other sources for use in generating one or more UWB transmission schedules, such as from another UWB network in the vicinity and/or a cellular core network entity (CNE) that directly provides cellular schedule information (such as a RAT TDD (Time Domain Duplex)) in a given geographic region.

At stage 1010, the scheduling controller 1002 may transmit a request for an interference report 1032 to the initiator 1004 of a corresponding cluster. For example, during the XRCP, the controller 1002 may include the request for the interference report in an RCM and may transmit the RCM to the initiator 1004.

At stage 1012, the initiator 1004 may transmit or relay requests for the interference reports 1034, 1036 to each responder 1006, 1008, respectively, in the cluster. For example, during a ranging round, the initiator 1004 may include the request for the interference report in a Poll-DTM and transmit the Poll-DTM to each of the responders 1006, 1008.

The requests for an interference report 1032, 1034, 1036 may include one or more parameters for one or more quality measurements of one or more UWB signals. For example, for each of the UWB anchors, the request for an interference report may include a range of ranging slot indices during which measurements are to be made. Other example parameters may include the duration for which the measurement are to be made (e.g., a portion of a ranging slot or the entire ranging slot), the UWB channel number to be measured, the types of metrics to be found (e.g., Signal to Interference and Noise Ratio (SINR), Received Signal Strength Indicator (RSSI), and the Power Spectral Density (PSD)). Other parameters that may represent a level of the interference to the UWB signals due to RAT signals may be included in the request for the interference report 1032, 1034, 1036.

At stage 1014, the initiator 1004 and each responder 1006, 1008 may obtain one or more measurements of one or more UWB signals. For example, the initiator 1004 may obtain one or more measurements of one or more UWB signals based on the request in the RCM transmitted by the scheduling controller 1002. Each responder 1006, 1008 may obtain one or more measurements of the one or more UWB signals based on the request in Poll-DTMs transmitted by the initiator 1004.

In one example, the UWB anchors in a cluster (e.g., initiator 1004 and responders 1006, 1008) may be configured to scan all UWB channels. In another example, the UWB anchors in the same cluster may be located within a threshold distance from each other and hence may observe similar interference characteristics. To increase efficiency, the UWB anchors in the same cluster may be configured to scan the UWB channels for RAT signal interference in a multiplexed manner. Referring to FIG. 11, an example multiplexed schedule 1100 for scanning of UWB channels is shown, where the UWB anchors (Anchor 1, Anchor 2, Anchor 3, Anchor 4) are configured to sequentially scan ten different UWB channels over ranging slots 1 through 5. For example, during ranging slot 1, Anchors 1, 2, 3, and 4 may be configured to scan UWB channels 5, 6, 7, and 8, respectively. During ranging slot 2, Anchors 1, 2, 3, and 4 may be configured to scan UWB channels 9, 10, 11, and 12, respectively. The schedule 1100 similarly multiplexes the scan performed by Anchors 1, 2, 3, and 4 during ranging slots 3, 4, and 5. At the completion of the scanning in ranging slot 5, each of the Anchors, 1, 2, 3, and 4 would have collectively scanned the ten UWB channels (UWB channel 5 to UWB channel 14) twice. By scheduling the scanning of UWB channels in this manner, the power consumption costs associated with the scanning may be reduced. Also, more UWB channels may be scanned more quickly, with lessor latency in receiving the interference reports by the scheduling controller 1002. In addition to multiplexing the scanning of UWB channels by UWB anchors within the same cluster, the multiplexing of the scanning may also be applied across multiple clusters. For example, when two clusters are within a threshold distance from each other, the UWB anchors in one cluster may be scheduled to scan half of a set of UWB channels, and the other cluster may be scheduled to scan the other half of the set of UWB channels (e.g., UWB anchors in a first cluster may be scheduled to scan UWB channels 5-9, and UWB anchors in a second cluster may be scheduled to scan UWB channels 10-14.)

Referring again to FIG. 10, at stage 1016, the initiator 1004 and each responder 1006, 1008 may generate their respective interference report based on the respective measurements of the UWB signals based on the request 1032, 1034, 1036. The interference report may include one or more measurements for one or more parameters contained in the request for interference reports 1032, 1034, 1036. The one or more measurements may further include time boundaries associated with one or more of the measurements. For example, referring again to FIG. 9, a responder in Cluster 1 may be configured to scan the UWB signals over a certain time period 922. The responder in Cluster 1 may observe interference for a portion of the time period 922 and may not observe interference for the remaining portion of the time period 922. The responder in Cluster 1 may be configured to report the one or more measurements of the interference for the time period 922 along with the time boundary of the interference window within the time period 922.

Referring again to FIG. 10, at stage 1018, the responders 1006 and 1008 may transmit their respective interference reports 1038, 1040 to the initiator 1004. For example, during one or more last slots of the same ranging round in which the request 1034 was received, the responder 1006 may transmit to the initiator 1004 the interference report 1038 that includes the one or more measurements obtained by the responder 1006, and the responder 1008 may transmit to the initiator 1004 the interference report 1040 that includes the one or more measurements obtained by the responder 1008. Referring again to FIG. 9, an initiator (e.g., initiator 1004) of Cluster 1 may transmit an RCM with a request for an interference report to a responder (e.g., responder 1006) during ranging round 2. Towards the ending ranging slots of ranging round 2 of the same ranging block, the responder 1006 may transmit to the initiator 1004 its corresponding interference report in a measurement report message (MRM) or a Resp DTM (e.g., Resp DTM 920). For another example, the transmission of the MRM or Resp DTM 920 by the responder 1006 may be delayed until ranging round 2 of a subsequent ranging block. The subsequent ranging block may be an immediately subsequent or a non-immediately subsequent ranging block from the ranging block during which the request for the interference report is received by the responder 1006. The transmission of the MRM or Resp DTM may be delayed until a subsequent ranging block when obtaining the interference measurements may require more time than a ranging round provides (e.g., based on the number of UWB channels to scan) or when the number of UWB anchors in a cluster is such that more time than a ranging round provides may be required for each UWB anchor to transmit its corresponding interference report to the initiator 1004.

Referring again to FIG. 10, at stage 1020, the initiator 1004 may collect the interference reports 1038, 1040 from the responders 1006, 1008.

At stage 1022, the initiator 1004 may generate an amalgamated interference report 1042 that amalgamates the one or more measurements obtained by the initiator 1004 and the one or more measurements in the interference reports 1038, 1040 from the responders 1006, 1008.

At stage 1024, the initiator 1004 may transmit the amalgamated interference report 1042 to the scheduling controller 1002. For example, the initiator 1004 may transmit the amalgamated interference report 1042 during the XRCP of a subsequent ranging block. The subsequent ranging block may be an immediately subsequent ranging block, or a non-immediately subsequent ranging block from the current ranging block. The transmission of the amalgamated interference report 1042 may be delayed until a subsequent ranging block when the number of clusters in the UWB network is such that more time than a ranging round provides may be required for the scheduling controller 1002 to receive the amalgamated interference reports 1042 from each initiator 1004 in the UWB network.

At stage 1026, the scheduling controller 1002 may generate one or more UWB transmission schedules based on the amalgamated interference report 1042 from the initiator 1004 and one or more amalgamated interference reports 1050 from other initiators corresponding to other clusters in the UWB network. For example, the scheduling controller 1002 may compute an overall metric for each of the UWB channels based on the amalgamated interference reports 1042, 1050 received from the initiators in the UWB network. The overall metric may be based on the level of interference observed in the UWB channels, as reported in the amalgamated interference reports 1042, 1050. The scheduling controller 1002 may rank the UWB channels based on the overall metric and generate one or more UWB transmission schedules based on the rankings of the UWB channels. For example, the scheduling controller 1002 may obtain one or more metrics for one or more UWB channels from the one or more amalgamated interference reports (e.g., the SINR, RSSI, and PSD, or some combination of thereof, for the one or more UWB channels). The scheduling controller 1002 may determine an average or a median of the one or more metrics for the one or more UWB channels (e.g., an average SINR or a median RSSI). The scheduling controller 1002 may determine an overall metric for each of the one or more UWB channels using the one or more metrics and may apply weights to the one or more metrics in the determination of the overall metric. The scheduling controller 1002 may rank the UWB channels based on the overall metric for the one or more UWB channels. For example, the UWB channels may be ranked in decreasing order of average SINR, median RSSI, or some combination thereof. The scheduling controller 1002 generates one or more UWB transmission schedules to configure the one or more clusters to transmit UWB signals over the UWB channels that are most favorable to a corresponding cluster, i.e., the UWB channel on which a corresponding cluster is observed to experience the least amount of interference from RAT signals.

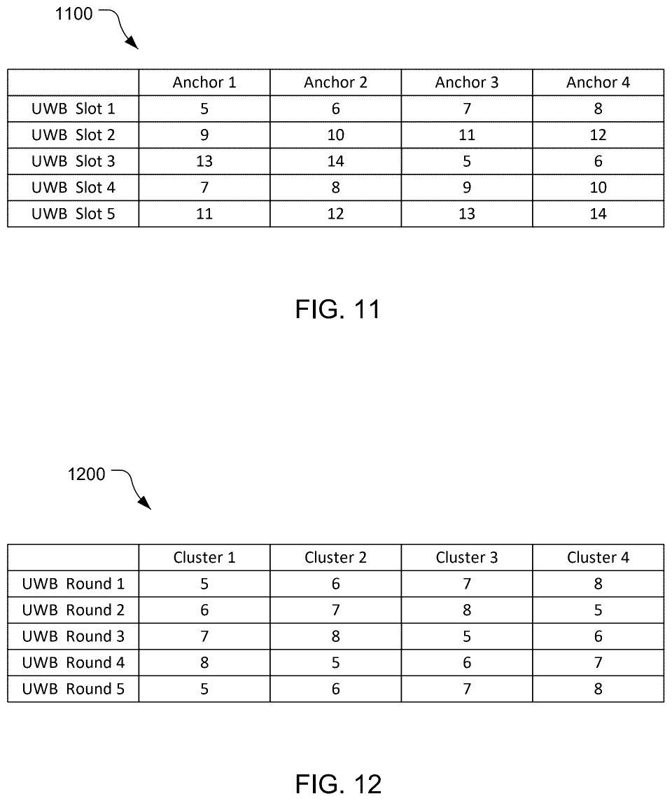

In an example embodiment, different UWB transmission schedules may be generated for different ranging blocks. In another example embodiment, different UWB transmission schedules may be generated for different clusters based on the UWB channels most favorable to each cluster. In another example embodiment, when two or more clusters are located within a threshold distance of each other, and similar ranks for the UWB channels may be determined for the two or more clusters, the UWB transmission schedules may cyclically rotate the UWB channel transmission. Referring to FIG. 12, in an example UWB transmission schedule 1200 with four clusters (e.g., Cluster 1, Cluster 2, Cluster 3, and Cluster 4) that share four UWB channels (UWB channels 5, 6, 7, and 8), the UWB transmissions may be cyclically rotated between the clusters and between the UWB ranging rounds (e.g., Ranging Round 1, Ranging Round 2, Ranging Round 3, Ranging Round 4, and Ranging Round 5). The cyclical rotation between the ranging rounds may also be applied to ranging slots in a similar manner.

Referring again to FIG. 10, at stage 1028, the scheduling controller 1002 may transmit the one or more UWB transmission schedules to the initiator 1004 and the other initiators in the UWB network. For example, the scheduling controller 1002 may transmit the UWB transmission schedule 1044 to the initiator 1004 and other initiators in the UWB network in the same XRCP.

At stage 1030, the initiator 1004 may transmit the one or more UWB transmission schedules to each responder 1006, 1008, respectively. For example, the initiator 1004 may transmit the UWB transmission schedule 1046 to responder 1006, and the UWB transmission schedule 1048 to the responder 1008.

In an example embodiment, one or more initiators corresponding to one or more clusters may calculate the overall metrics for one or more UWB channels based on the one or more interference reports for the initiator's corresponding cluster and may transmit the overall metrics to the scheduling controller 1002. By transmitting the overall metrics instead of the amalgamated interference report, the amount of data to be transmitted to the scheduling controller 1002 may be reduced. The scheduling controller 1002 may generate the one or more UWB transmission schedules based on the overall metrics as received from the one or more initiators.

In another example embodiment, in addition to calculating the overall metrics for one or more UWB channels based on the interference reports for the initiator's corresponding cluster, the one or more initiators corresponding to one or more clusters may generate the one or more UWB transmission schedules for the initiator's corresponding cluster based on the overall metrics for the initiator's corresponding cluster, and transmit the one or more UWB transmission schedules to the responders in its corresponding cluster and to the initiators assigned to subsequent ranging rounds. For example, each initiator in the UWB network may generate its corresponding UWB transmission schedules based on the interference reports for its corresponding cluster and based on the UWB transmission schedules received from the other initiators. The clusters in the UWB network may adapt their corresponding UWB transmission schedules on a ranging-round-by-ranging-round basis, which enables a near real-time learning of the RAT signal interference pattern. The one or more initiators in the UWB network may further transmit their respective amalgamated interference reports and their respective one or more UWB transmission schedules to the scheduling controller 1002. The scheduling controller 1002 may analyze the respective amalgamated interference reports and may override one or more of the UWB transmission schedules based on the analysis.

In another example embodiment, the one or more UWB transmission schedules may be time aligned with the RAT frames based on the RAT signal interference pattern. For example, when a structured pattern for the RAT signal interference is identified (such as a TDD schedule that repeats periodically), the UWB transmission schedule may align the start of a ranging block with the start of a RAT frame based on the measurements in the amalgamated interference reports. As described above with reference to FIG. 7, the duration of a ranging round 700 may be the same as the duration of a RAT frame 740, and the duration of a ranging slot may be the same as the duration of a RAT subframe 770. By aligning the start of a ranging block with the start of a RAT frame, interference from RAT signals during a RAT subframe may be limited to the corresponding ranging slot. In another example embodiment, the scheduling controller 1002 may include a cellular radio, which allows the scheduling controller 1002 to align the start of the ranging block with the start of the RAT frame directly, allowing for a more accurate alignment.

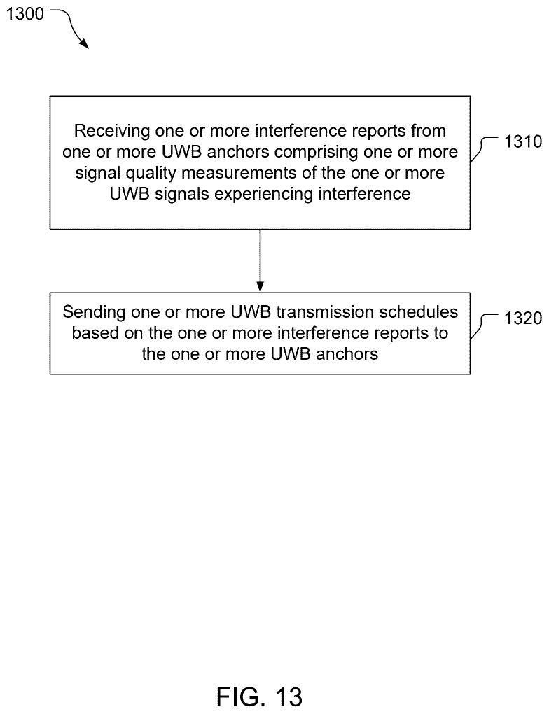

Referring to FIG. 13, and with further reference to FIGS. 3 and 10, a method 1300 for adaptive scheduling of UWB transmissions for one or more UWB anchors in a UWB network includes the stages shown. The UWB anchor 300 shown in FIG. 3 (e.g., the UWB unit 360) may be an example of a scheduling controller 1002, initiator 1004, and/or a responder 1006, 1008. The method 1300 may be altered, e.g., by having one or more stages added, removed, rearranged, combined, performed concurrently, and/or by having one or more single stages split into multiple stages.

At stage 1310, the method 1300 includes receiving one or more interference reports from one or more UWB anchors comprising one or more signal quality measurements of the one or more UWB signals experiencing interference. For example, the one or more UWB signals may experience interference from one or more other signals. The one or more signals may include one or more RAT signals. For example, the scheduling controller 1002 may send one or more requests for interference reports to one or more initiators corresponding to one or more clusters of one or more responders in a UWB network. During an XRCP, the scheduling controller 1002 may include the one or more requests for interference reports in an RCM and may transmit the RCM to the one or more initiators. The processor 310, possibly in combination with the memory 330, possibly in combination with the transceiver 320 may comprise means for receiving the one or more interference reports from the one or more UWB anchors comprising the one or more signal quality measurements of the one or more UWB signals experiencing interference from the one or more other signals.

As a further example, the one or more initiators corresponding to one or more clusters in the UWB network may receive one or more requests for one or more interference reports from the scheduling controller 1002. The one or more initiators may send the one or more requests for the one or more interference reports to the one or more responders in the corresponding cluster. During the XRCP, the initiator 1004 may receive the request for the interference report in an RCM from the scheduling controller 1002. The initiator 1004 may transmit the requests for the interference reports 1034, 1036 to each responder 1006, 1008, respectively, in the corresponding cluster. For example, during a ranging round, the initiator 1004 may include the request for the interference report in a Poll-DTM and transmit the Poll-DTM to each of the responders 1006, 1008. The initiator 1004 may obtain one or more signal quality measurements of one or more UWB signals based on the request 1032. The initiator 1004 may obtain one or more measurements of the one or more UWB signals based on the request 1032 in the RCM transmitted by the scheduling controller 1002.

As a further example, the one or more responders of the corresponding cluster may receive one or more requests for one or more interference reports for one or more UWB signals from the initiator of the corresponding cluster. The responders 1006, 1008 of the corresponding cluster may obtain one or more signal quality measurements of one or more UWB signals based on the requests 1034, 1036. The responders 1006, 1008 of the corresponding cluster may generate one or more interference reports 1038, 1040 comprising the one or more signal quality measurements. For example, during a ranging round, each responder 1006, 1008 in the corresponding cluster may receive a Poll-DTM from the initiator 1004 that includes the request for the interference report 1034, 1036. Each responder 1006, 1008 may obtain one or more measurements of one or more UWB signals based on the request 1034, 1036 in the Poll-DTMs transmitted by the initiator 1004. Each responder 1006, 1008 may generate their respective interference report 1038, 1040 based on the respective signal quality measurements of the UWB signals obtained based on the request 1034, 1036. The responders 1006, 1008 of the corresponding cluster may send the interference reports 1038, 1040 to the initiator 1004 of the corresponding cluster. For example, during one or more last ranging slots of the same ranging round, the responder 1006 may transmit to the initiator 1004 a measurement report message (MRM) with the measurements obtained by the responder 1006, and the responder 1008 may transmit to the initiator 1004 an MRM that includes the measurements obtained by the responder 1008. For another example, during a subsequent ranging block, the responder 1006 may transmit to the initiator 1004 a Resp-DTM with the measurements obtained by the responder 1006, and the responder 1008 may transmit to the initiator 1004 a Resp-DTM that includes the measurements obtained by the responder 1008. The subsequent ranging block may be an immediately subsequent or a non-immediately subsequent ranging block from the current ranging block.

As a further example, the one or more initiators may receive one or more interference reports from the one or more responders in the corresponding cluster, the one or more interference reports comprising one or more signal quality measurements of the one or more UWB signals obtained by the one or more responders of the corresponding cluster based on the request. The one or more initiators may send the one or more amalgamated interference reports to the controller 1002. For example, the initiator 1004 may receive a measurement report message (MRM) with the measurements obtained by the responder 1006 and another MRM with the measurements obtained by the responder 1008. For another example, during a subsequent ranging block, the initiator 1004 may receive a Resp-DTM transmitted by the responder 1006 that includes the measurements obtained by the responder 1006 and a Resp-DTM transmitted by the responder 1008 that includes the measurements obtained by the responder 1008. The initiator 1004 may generate an amalgamated interference report 1042 comprising the one or more signal quality measurements obtained by the initiator 1004 and the responders 1006, 1008 of the corresponding cluster. For example, the initiator 1004 may collect the interference reports 1038, 1040 from the responders 1006, 1008 and generate an amalgamated interference report 1042 that amalgamates the one or more measurements obtained by the initiator 1004 and the one or more measurements in the interference reports 1038, 1040 from the responders 1006, 1008. The initiator 1004 may transmit the amalgamated interference report 1042 during a subsequent second XRCP. The subsequent second XRCP may be the XRCP in an immediately subsequent ranging round or a non-immediately subsequent ranging round from the current ranging round.

The scheduling controller 1002 may receive one or more amalgamated interference reports 1042, 1050 from the one or more initiators comprising one or more signal quality measurements of the one or more UWB signals obtained by the one or more responders in the corresponding clusters in the UWB network. The one or more amalgamated interference reports 1042, 1050 may comprise one or more collections of interference reports from the one or more responders in the corresponding clusters.

At stage 1320, the method 1300 includes sending one or more UWB transmission schedules based on the one or more interference reports to the one or more UWB anchors. For example, the scheduling controller 1002 may generate the one or more UWB transmission schedules based on the one or more amalgamated interference reports from the one or more initiators, such that interference from the RAT signals may be mitigated or avoided. The scheduling controller 1002 may transmit the one or more UWB transmission schedules to the initiator 1004 and other initiators in the UWB network in the same XRCP. The processor 310, possibly in combination with the memory 330, possibly in combination with the transceiver 320 may comprise means for sending the one or more UWB transmission schedules based on the one or more interference reports to the one or more UWB anchors.

### Implementation Examples

Implementation examples are provided in the following numbered clauses.

Clause 1. A method for adaptive scheduling of Ultra-Wideband (UWB) transmissions for one or more UWB anchors in a UWB network, the method comprising: receiving one or more interference reports from the one or more UWB anchors comprising one or more signal quality measurements of one or more UWB signals experiencing interference; and sending one or more UWB transmission schedules based on the one or more interference reports to the one or more UWB anchors.

Clause 2. The method of clause 1, wherein sending the one or more UWB transmission schedules based on the one or more interference reports to the one or more UWB anchors comprises: assigning one or more clusters of the one or more UWB anchors to transmit on one or more of the plurality of UWB channels based on the one or more interference reports.

Clause 3. The method of clause 2, wherein assigning the one or more clusters of the one or more UWB anchors to transmit on the one or more of the plurality of UWB channels based on the one or more interference reports comprises: assigning a cluster of the one or more clusters to transmit on a UWB channel of the plurality of UWB channels on which the cluster is observed to experience a least amount of interference.

Clause 4. The method of clause 1, wherein the one or more signal quality measurements comprise one or more measurements of interference of the one or more UWB signals from one or more radio access technology (RAT) signals.

Clause 5. The method of clause 1, wherein receiving the one or more interference reports from the one or more UWB anchors comprises: sending one or more requests for the one or more interference reports for the one or more UWB signals to one or more initiators corresponding to one or more clusters of one or more responders in the UWB network; and receiving one or more amalgamated interference reports from the one or more initiators comprising the one or more signal quality measurements of the one or more UWB signals obtained by the one or more responders in the UWB network.

Clause 6. The method of clause 5, wherein sending the one or more UWB transmission schedules based on the one or more interference reports to the one or more UWB anchors comprises: sending the one or more UWB transmission schedules to the corresponding one or more initiators; and sending, by the one or more initiators, the one or more UWB transmission schedules to one or more responders of one or more clusters corresponding to the one or more initiators.

Clause 7. The method of clause 5, further comprising: receiving, from a signaling controller, the one or more request for the one or more interference reports by an initiator of the one or more initiators corresponding a cluster of the one or more clusters; sending, by the initiator, the one or more requests for the one or more interference reports to the one or more responders in the corresponding cluster; obtaining, by the initiator, one or more first signal quality measurements of the one or more UWB signals based on the one or more requests; receiving, by the initiator from the one or more responders in the corresponding cluster, one or more interference reports comprising one or more second signal quality measurements of the one or more UWB signals obtained by the one or more responders of the corresponding cluster based on the one or more requests from the initiator; and sending, by the initiator, the one or more amalgamated interference reports comprising the one or more first signal quality measurements and the one or more second signal quality measurements to the signaling controller.

Clause 8. The method of clause 7, further comprising: receiving the one or more requests for the one or more interference reports from the initiator of the corresponding cluster by the one or more responders of the corresponding cluster; obtaining, by the one or more responders of the corresponding cluster, the one or more second signal quality measurements of the one or more UWB signals based on the one or more requests from the initiator of the corresponding cluster; and sending the one or more interference reports comprising the one or more second signal quality measurements by the one or more responders of the corresponding cluster to the initiator of the corresponding cluster.

Clause 9. The method of clause 8, wherein the one or more requests for the one or more interference reports from the initiator comprise one or more parameters for the one or more signal quality measurements, wherein the one or more parameters is selected from a group consisting of: a UWB channel scanning schedule; a range of ranging slot indices during which the one or more signal quality measurements are to be made; a duration for which the one or more signal quality measurements are to be made; a UWB channel number to be measured; and one or more metrics representing a level of interference from the one or more other signals.

Clause 10. An Ultra-Wideband (UWB) device, comprising: at least one transmitter; at least one memory; and at least one processor, communicatively coupled to the at least one transmitter and the at least one memory, with at least one of the at least one memory or the at least one processor comprising instructions to cause the at least one processor to: receive one or more interference reports from one or more UWB anchors in a UWB network, the one or more interference reports comprising one or more signal quality measurements of one or more UWB signals experiencing interference; and send one or more UWB transmission schedules based on the one or more interference reports to the one or more UWB anchors.

Clause 11. The device of clause 10, wherein the at least one processor comprising instructions to cause the at least one processor to send the one or more UWB transmission schedules based on the one or more interference reports to the one or more UWB anchors comprises instructions to cause the at least one processor to: assign one or more clusters of the one or more UWB anchors to transmit on one or more of the plurality of UWB channels based on the one or more interference reports.

Clause 12. The device of clause 11, wherein the at least one processor comprising instructions to cause the at least one processor to assign the one or more clusters of the one or more UWB anchors to transmit on the one or more of the plurality of UWB channels based on the one or more interference reports comprises instructions to cause the at least one processor to: assign a cluster of the one or more clusters to transmit on a UWB channel of the plurality of UWB channels on which the cluster is observed to experience a least amount of interference.

Clause 13. The device of clause 10, wherein the one or more signal quality measurements comprise one or more measurements of interference of the one or more UWB signals from one or more radio access technology (RAT) signals.

Clause 14. The device of clause 10, wherein the at least one processor comprising instructions to cause the at least one processor to receive the one or more interference reports from the one or more UWB anchors comprises instructions to cause the at least one processor to: send one or more requests for the one or more interference reports for the one or more UWB signals to one or more initiators corresponding to one or more clusters of one or more responders in the UWB network; and receive one or more amalgamated interference reports from the one or more initiators comprising the one or more signal quality measurements of the one or more UWB signals obtained by the one or more responders in the UWB network.

Clause 15. The device of clause 14, wherein the at least one processor comprising instructions to cause the at least one processor to send the one or more UWB transmission schedules based on the one or more interference reports to the one or more UWB anchors comprises instructions to cause the at least one processor to: send the one or more UWB transmission schedules to the corresponding one or more initiators; and send, by the one or more initiators, the one or more UWB transmission schedules to one or more responders of one or more clusters corresponding to the one or more initiators.

Clause 16. The device of clause 14, further comprising instructions to cause the at least one processor to: receive, from a signaling controller, the one or more request for the one or more interference reports by an initiator of the one or more initiators corresponding a cluster of the one or more clusters; send, by the initiator, the one or more requests for the one or more interference reports to the one or more responders in the corresponding cluster; obtain, by the initiator, one or more first signal quality measurements of the one or more UWB signals based on the one or more requests; receive, by the initiator from the one or more responders in the corresponding cluster, one or more interference reports comprising one or more second signal quality measurements of the one or more UWB signals obtained by the one or more responders of the corresponding cluster based on the one or more requests from the initiator; and send, by the initiator, the one or more amalgamated interference reports comprising the one or more first signal quality measurements and the one or more second signal quality measurements to the signaling controller.

Clause 17. The device of clause 16, further comprising instructions to cause the at least one processor to: receive the one or more requests for the one or more interference reports from the initiator of the corresponding cluster by the one or more responders of the corresponding cluster; obtain, by the one or more responders of the corresponding cluster, the one or more second signal quality measurements of the one or more UWB signals based on the one or more requests from the initiator of the corresponding cluster; and send the one or more interference reports comprising the one or more second signal quality measurements by the one or more responders of the corresponding cluster to the initiator of the corresponding cluster.

Clause 18. The device of clause 17, wherein the one or more requests for the one or more interference reports from the initiator comprise one or more parameters for the one or more signal quality measurements, wherein the one or more parameters is selected from a group consisting of: a UWB channel scanning schedule; a range of ranging slot indices during which the one or more signal quality measurements are to be made; a duration for which the one or more signal quality measurements are to be made; a UWB channel number to be measured; and one or more metrics representing a level of interference from the one or more other signals.

Clause 19. An Ultra-Wideband (UWB) device, comprising: means for receiving one or more interference reports from one or more UWB anchors in a UWB network, the one or more interference reports comprising one or more signal quality measurements of one or more UWB signals experiencing interference; and sending one or more UWB transmission schedules based on the one or more interference reports to the one or more UWB anchors.

Clause 20. The device of clause 19, wherein the means for sending the one or more UWB transmission schedules based on the one or more interference reports to the one or more UWB anchors comprises: means for assigning one or more clusters of the one or more UWB anchors to transmit on one or more of the plurality of UWB channels based on the one or more interference reports.

Clause 21. The device of clause 20, wherein the means for assigning the one or more clusters of the one or more UWB anchors to transmit on the one or more of the plurality of UWB channels based on the one or more interference reports comprises: means for assigning a cluster of the one or more clusters to transmit on a UWB channel of the plurality of UWB channels on which the cluster is observed to experience a least amount of interference.

Clause 22. The device of clause 19, wherein the one or more signal quality measurements comprise one or more measurements of interference of the one or more UWB signals from one or more radio access technology (RAT) signals.

Clause 23. The device of clause 19, wherein the means for receiving the one or more interference reports from the one or more UWB anchors comprises: means for sending one or more requests for the one or more interference reports for the one or more UWB signals to one or more initiators corresponding to one or more clusters of one or more responders in the UWB network; and means for receiving one or more amalgamated interference reports from the one or more initiators comprising the one or more signal quality measurements of the one or more UWB signals obtained by the one or more responders in the UWB network.

Clause 24. The device of clause 23, wherein the means for sending the one or more UWB transmission schedules based on the one or more interference reports to the one or more UWB anchors comprises: means for sending the one or more UWB transmission schedules to the corresponding one or more initiators; and means for sending, by the one or more initiators, the one or more UWB transmission schedules to one or more responders of one or more clusters corresponding to the one or more initiators.

Clause 25. The device of clause 24, further comprising: means for receiving, from a signaling controller, the one or more request for the one or more interference reports by an initiator of the one or more initiators corresponding a cluster of the one or more clusters; means for sending, by the initiator, the one or more requests for the one or more interference reports to the one or more responders in the corresponding cluster; means for obtaining, by the initiator, one or more first signal quality measurements of the one or more UWB signals based on the one or more requests; means for receiving, by the initiator from the one or more responders in the corresponding cluster, one or more interference reports comprising one or more second signal quality measurements of the one or more UWB signals obtained by the one or more responders of the corresponding cluster based on the one or more requests from the initiator; and means for sending, by the initiator, the one or more amalgamated interference reports comprising the one or more first signal quality measurements and the one or more second signal quality measurements to the signaling controller.

Clause 26. The device of clause 25, further comprising: means for receiving the one or more requests for the one or more interference reports from the initiator of the corresponding cluster by the one or more responders of the corresponding cluster; means for obtaining, by the one or more responders of the corresponding cluster, the one or more second signal quality measurements of the one or more UWB signals based on the one or more requests from the initiator of the corresponding cluster; and means for sending the one or more interference reports comprising the one or more second signal quality measurements by the one or more responders of the corresponding cluster to the initiator of the corresponding cluster.

Clause 27. The device of clause 26, wherein the one or more requests for the one or more interference reports from the initiator comprise one or more parameters for the one or more signal quality measurements, wherein the one or more parameters is selected from a group consisting of: a UWB channel scanning schedule; a range of ranging slot indices during which the one or more signal quality measurements are to be made; a duration for which the one or more signal quality measurements are to be made; a UWB channel number to be measured; and one or more metrics representing a level of interference from the one or more other signals.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection, between wireless communication devices. A wireless communication system (also called a wireless communications system, a wireless communication network, or a wireless communications network) may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A method for adaptive scheduling of Ultra-Wideband (UWB) transmissions for one or more UWB anchors in a UWB network, the method comprising:
receiving one or more interference reports from the one or more UWB anchors comprising one or more signal quality measurements of one or more UWB signals experiencing interference; and
sending one or more UWB transmission schedules based on the one or more interference reports to the one or more UWB anchors.

2. The method of claim 1, wherein sending the one or more UWB transmission schedules based on the one or more interference reports to the one or more UWB anchors comprises:
assigning one or more clusters of the one or more UWB anchors to transmit on one or more of the plurality of UWB channels based on the one or more interference reports.

3. The method of claim 2, wherein assigning the one or more clusters of the one or more UWB anchors to transmit on the one or more of the plurality of UWB channels based on the one or more interference reports comprises: assigning a cluster of the one or more clusters to transmit on a UWB channel of the plurality of UWB channels on which the cluster is observed to experience a least amount of interference.

4. The method of claim 1, wherein the one or more signal quality measurements comprise one or more measurements of interference of the one or more UWB signals from one or more radio access technology (RAT) signals.

5. The method of claim 1, wherein receiving the one or more interference reports from the one or more UWB anchors comprises:
sending one or more requests for the one or more interference reports for the one or more UWB signals to one or more initiators corresponding to one or more clusters of one or more responders in the UWB network; and
receiving one or more amalgamated interference reports from the one or more initiators comprising the one or more signal quality measurements of the one or more UWB signals obtained by the one or more responders in the UWB network.

6. The method of claim 5, wherein sending the one or more UWB transmission schedules based on the one or more interference reports to the one or more UWB anchors comprises:
sending the one or more UWB transmission schedules to the corresponding one or more initiators; and
sending, by the one or more initiators, the one or more UWB transmission schedules to one or more responders of one or more clusters corresponding to the one or more initiators.

7. The method of claim 5, further comprising:
receiving, from a signaling controller, the one or more request for the one or more interference reports by an initiator of the one or more initiators corresponding a cluster of the one or more clusters;
sending, by the initiator, the one or more requests for the one or more interference reports to the one or more responders in the corresponding cluster;
obtaining, by the initiator, one or more first signal quality measurements of the one or more UWB signals based on the one or more requests;
receiving, by the initiator from the one or more responders in the corresponding cluster, one or more interference reports comprising one or more second signal quality measurements of the one or more UWB signals obtained by the one or more responders of the corresponding cluster based on the one or more requests from the initiator; and
sending, by the initiator, the one or more amalgamated interference reports comprising the one or more first signal quality measurements and the one or more second signal quality measurements to the signaling controller.

8. The method of claim 7, further comprising:
receiving the one or more requests for the one or more interference reports from the initiator of the corresponding cluster by the one or more responders of the corresponding cluster;
obtaining, by the one or more responders of the corresponding cluster, the one or more second signal quality measurements of the one or more UWB signals based on the one or more requests from the initiator of the corresponding cluster; and
sending the one or more interference reports comprising the one or more second signal quality measurements by the one or more responders of the corresponding cluster to the initiator of the corresponding cluster.

9. The method of claim 8, wherein the one or more requests for the one or more interference reports from the initiator comprise one or more parameters for the one or more signal quality measurements, wherein the one or more parameters is selected from a group consisting of: a UWB channel scanning schedule; a range of ranging slot indices during which the one or more signal quality measurements are to be made; a duration for which the one or more signal quality measurements are to be made; a UWB channel number to be measured; and one or more metrics representing a level of interference from the one or more other signals.

10. An Ultra-Wideband (UWB) device, comprising:
at least one transmitter;
at least one memory; and
at least one processor, communicatively coupled to the at least one transmitter and the at least one memory, with at least one of the at least one memory or the at least one processor comprising instructions to cause the at least one processor to:
receive one or more interference reports from one or more UWB anchors in a UWB network, the one or more interference reports comprising one or more signal quality measurements of one or more UWB signals experiencing interference; and
send one or more UWB transmission schedules based on the one or more interference reports to the one or more UWB anchors.

11. The device of claim 10, wherein the at least one processor comprising instructions to cause the at least one processor to send the one or more UWB transmission schedules based on the one or more interference reports to the one or more UWB anchors comprises instructions to cause the at least one processor to:
assign one or more clusters of the one or more UWB anchors to transmit on one or more of the plurality of UWB channels based on the one or more interference reports.

12. The device of claim 11, wherein the at least one processor comprising instructions to cause the at least one processor to assign the one or more clusters of the one or more UWB anchors to transmit on the one or more of the plurality of UWB channels based on the one or more interference reports comprises instructions to cause the at least one processor to: assign a cluster of the one or more clusters to transmit on a UWB channel of the plurality of UWB channels on which the cluster is observed to experience a least amount of interference.

13. The device of claim 10, wherein the one or more signal quality measurements comprise one or more measurements of interference of the one or more UWB signals from one or more radio access technology (RAT) signals.

14. The device of claim 10, wherein the at least one processor comprising instructions to cause the at least one processor to receive the one or more interference reports from the one or more UWB anchors comprises instructions to cause the at least one processor to:
send one or more requests for the one or more interference reports for the one or more UWB signals to one or more initiators corresponding to one or more clusters of one or more responders in the UWB network; and
receive one or more amalgamated interference reports from the one or more initiators comprising the one or more signal quality measurements of the one or more UWB signals obtained by the one or more responders in the UWB network.

15. The device of claim 14, wherein the at least one processor comprising instructions to cause the at least one processor to send the one or more UWB transmission schedules based on the one or more interference reports to the one or more UWB anchors comprises instructions to cause the at least one processor to:
send the one or more UWB transmission schedules to the corresponding one or more initiators; and
send, by the one or more initiators, the one or more UWB transmission schedules to one or more responders of one or more clusters corresponding to the one or more initiators.

16. The device of claim 14, further comprising instructions to cause the at least one processor to:
receive, from a signaling controller, the one or more request for the one or more interference reports by an initiator of the one or more initiators corresponding a cluster of the one or more clusters;
send, by the initiator, the one or more requests for the one or more interference reports to the one or more responders in the corresponding cluster;
obtain, by the initiator, one or more first signal quality measurements of the one or more UWB signals based on the one or more requests;
receive, by the initiator from the one or more responders in the corresponding cluster, one or more interference reports comprising one or more second signal quality measurements of the one or more UWB signals obtained by the one or more responders of the corresponding cluster based on the one or more requests from the initiator; and
send, by the initiator, the one or more amalgamated interference reports comprising the one or more first signal quality measurements and the one or more second signal quality measurements to the signaling controller.

17. An Ultra-Wideband (UWB) device, comprising:
means for receiving one or more interference reports from one or more UWB anchors in a UWB network, the one or more interference reports comprising one or more signal quality measurements of one or more UWB signals experiencing interference; and
sending one or more UWB transmission schedules based on the one or more interference reports to the one or more UWB anchors.

18. The device of claim 17, wherein the means for sending the one or more UWB transmission schedules based on the one or more interference reports to the one or more UWB anchors comprises:
means for assigning one or more clusters of the one or more UWB anchors to transmit on one or more of the plurality of UWB channels based on the one or more interference reports.

19. The device of claim 18, wherein the means for assigning the one or more clusters of the one or more UWB anchors to transmit on the one or more of the plurality of UWB channels based on the one or more interference reports comprises: means for assigning a cluster of the one or more clusters to transmit on a UWB channel of the plurality of UWB channels on which the cluster is observed to experience a least amount of interference.

20. The device of claim 17, wherein the one or more signal quality measurements comprise one or more measurements of interference of the one or more UWB signals from one or more radio access technology (RAT) signals.
